(19) United States
(12) Patent Application Publication
(10) Pub. No.: US 2009/0110510 A1
(43) Pub. Date: Apr. 30, 2009

(54) WASHER INCLUDING PROTRUSIONS FOR USE IN A FASTENER ASSEMBLY

(75) Inventors: Ronald Ralph Cairo, Greer, SC (US); Sujith Sathian, Simpsonville, SC (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/925,040

(22) Filed: Oct. 26, 2007

(51) Int. Cl. F16B 39/02; F16B 43/00

(52) U.S. Cl. 411/197; 411/371.2

(57) ABSTRACT

A washer, including a body having a first face, a second face, and an aperture extending through the body from the first face to the second face, and a plurality of protrusions extending from at least one of the first face and the second face. The plurality of the protrusions have sufficient structural integrity to create a plurality of corresponding deformations in a separate mating surface during compressive loading of the washer against the separate mating surface.

### BACKGROUND OF THE INVENTION

A conventional fastener assembly includes a bolt, a bolt receiving member, and at least two washers. Typically, when the conventional fastener assembly is assembled for highly loaded joints or interfaces, the fastener assembly is subjected to high levels of torque to generate pre-loads and stress. The washers serve to distribute the pre-loads.

Conventional fastener assemblies that incorporate conventional washers may be used in a variety of industrial applications. In one example, in wind towers, wind loading subjects the towers to flexural fatigue and high vibratory stress that tends to loosen the conventional fastener assemblies incorporating the conventional washers. Consequently, these fastener assemblies sometimes require maintenance or replacement before their design life is achieved. In addition, the washers themselves may deform and increase the risk of failures such as slippage and deformation.

### BRIEF DESCRIPTION OF THE INVENTION

In accordance with an aspect of the invention, a washer is provided that comprises a body having a first face, a second face, and an aperture extending through the body from the first face to the second face, and a plurality of protrusions extending from at least one of the first face and the second face. The plurality of the protrusions have sufficient structural integrity to create a plurality of corresponding deformations in a separate mating surface during compressive loading of the washer against the separate mating surface.

In accordance with another aspect of the invention, a fastener assembly is provided that comprises a fastener body having a shank and a bolt head, a shank receiving member capable of drawing the bolt head in a direction to shorten a distance between the shank receiving member and the bolt head, and a washer having a plurality of protrusions extending from at least one surface of the washers. The protrusions are capable of deforming at least one of the bolt head and a surface with which the washer makes contact during the drawing of the bolt head in the direction to shorten the distance between the shank receiving member and the bolt head.

In accordance with another aspect of the invention, a fastener assembly is provided that comprises a fastener body, including a shank and a bolt head, a washer, disposed between a mating surface of the fastener body bolt head and a mating surface of a mating part, the washer including a body having first and second faces and an aperture extending through the body from one face to the other, and a plurality of protrusions protruding from at least one of the faces, and a shank receiving member to draw the mating surface of the fastener body bolt head toward the mating surface of the mating part such that the mating surfaces contact the first and second faces of the washer following sufficient deformations of each of the protrusions and the at least one corresponding mating surface.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 is a plan view of a washer in accordance with an embodiment of the invention;

FIG. 2 is a side view of the washer of FIG. 1;

FIG. 3 is a side view of a first fastener assembly including the washer of FIG. 1;

FIG. 4 is a side view of a second fastener assembly including the washer of FIG. 1;

FIGS. 5 and 6 are schematic diagrams showing the deformation of the protrusions and mating surfaces;

FIG. 7 is a side view of a washer according to an embodiment of the invention;

FIG. 8 is a side view of a third fastener assembly including a second washer;

FIG. 9 is a side view of a washer having angled protrusions.

FIG. 10 is a side view of a fourth fastener assembly including a washer having the angled protrusions of FIG. 9; and

FIG. 11 is a side view of a fifth fastener assembly including a washer having the angled protrusions of FIG. 9.

### DETAILED DESCRIPTION

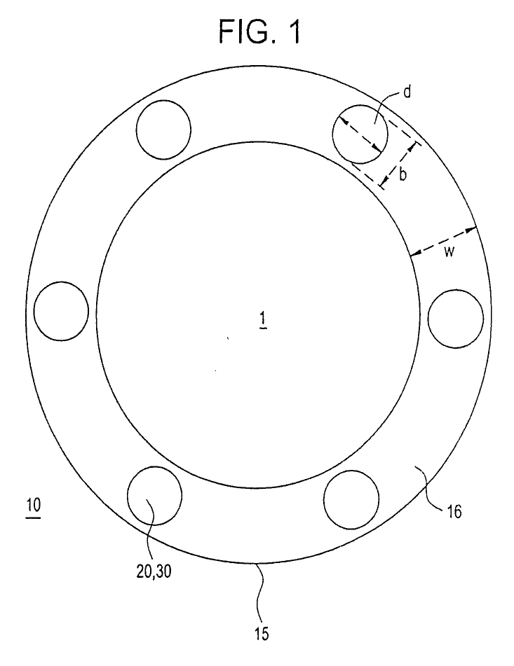

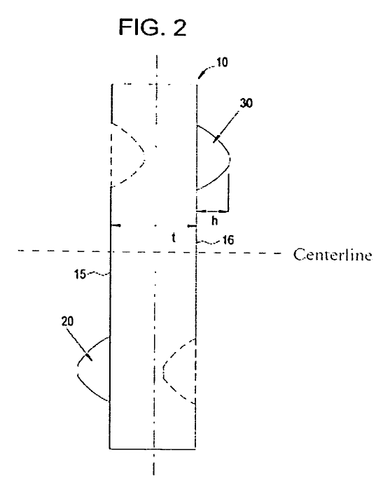

Referring to FIGS. 1 and 2, a washer 10 includes a body having first and second opposing faces 15 and 16, inner edges of which define an outer edge of an aperture 1. A plurality of protrusions 20, 30 protrude from at least one of the first and second faces 15 and 16 and may be organized in any arrangement that promotes a substantially uniform deformation of the protrusions 20 and 30 upon an application of an external force, such as a compressive load, in a direction normal to the faces 15 and 16.

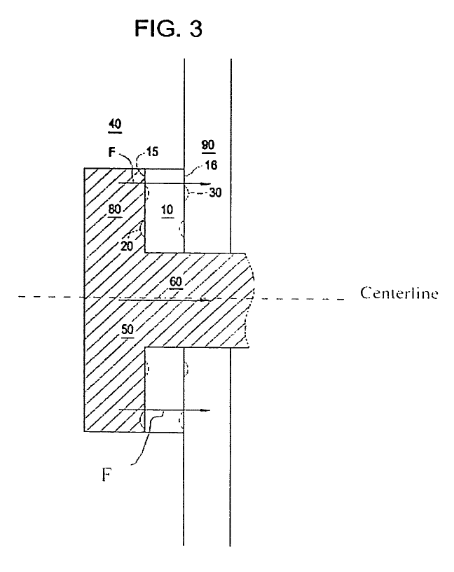

With reference to FIG. 3, a first fastener assembly 40, in which the washer 10 may be installed, includes a fastener body 50, such as a bolt, having a shank 60 and a bolt head 80 that has a larger diameter than that of the shank 60. The shank 60 extends through a first mating part 90. The washer 10 is disposed between the bolt head 80 and the first mating part 90. Upon an application of a force, F, such as a compressive load, indicated by the arrows in FIG. 3, that biases the bolt head 80 toward the first mating part 90, the washer 10 distributes pressure from the bolt head 80 to the first mating part 90.

In one possible embodiment of washer 10 to be installed in the first fastener assembly 40, as shown in FIG. 1, the arrangement of the protrusions 20 and 30 includes at least one of a set of three protrusions 20 protruding from face 15 and a set of three protrusions 30 protruding from face 16. Each of the protrusions 20 and 30 are arranged at substantially equal intervals from one another in a staggered format around the faces 15 and 16. Here, each protrusion 20 and 30 deforms substantially uniformly and causes substantially uniform deformations in corresponding respective surfaces of the bolt head 80 and the first mating part 90.

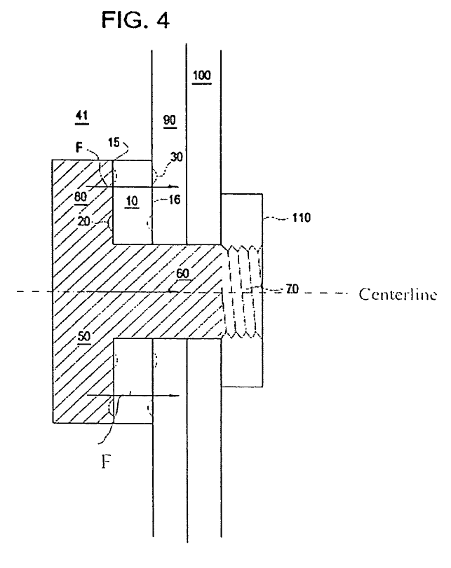

With reference to FIG. 4, which shows a second fastener assembly 41 and which will be discussed below, it is noted that the force, F, may be generated by an application of torque to a shank receiving member 110, such as a nut, with the fastener body 50 held still so as to tighten the shank receiving member 110 toward a second mating part 100 via threads 70 cut into the shank 60 and all interior surface of the shank receiving member 110. Of course, it is understood that the shank receiving member 110 could also be held still while the fastener body 50 is turned to achieve a similar result. It is also understood that the fastener body 50 and the shank receiving member 110 could be tightened in other ways, such as by a clamp.

As the amount of force, F, increases, the protrusions 20 and 30 of FIG. 4, and, where applicable, those of FIG. 3, penetrate the corresponding respective surfaces of the bolt head 80 and the first mating part 90 such that the protrusions 20 and 30 and the corresponding respective surfaces deform and interlock with one another while remaining substantially aligned.

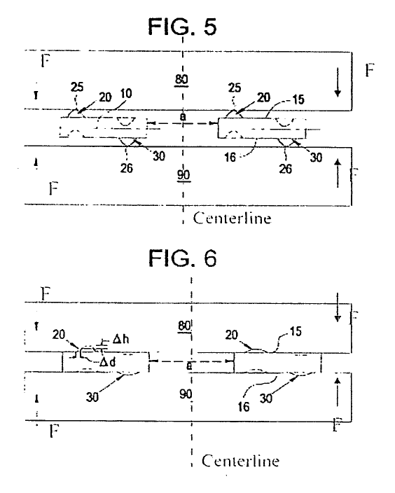

This deformation is shown schematically in the diagrams of FIGS. 5 and 6. At the time shown in FIG. 5, contact points 25 and 26 of respective surfaces of the bolt head 80 and the first mating part 90 begin to come into contact with the protrusions 20 and 30. Here, the pressure on each or the protrusions 20 and 30 and the contact points may be very large with respect to their relatively small surface areas. As a result, the material of the protrusions 20 and 30 and the surfaces at the contact points experience high localized stress that results in yielding and material flow. Continued increases in the force, F, results in continued yielding and material flow and, subsequently, metallurgical bonding, cold welding and galling between the materials of the protrusions 20 and 30 and the materials of the fastener body 50 and first mating part 90 at the contact points 25 and 26. The yielding, material flow, metallurgical bonding, cold welding and galling combine to increase a degree of locking between the washer 10 and the bolt head 80 and the first mating part 90.

By the time illustrated in FIG. 6, force, F, has sizably increased and the surfaces of the bolt head 80 and the first mating part 90 and the faces of the washer 10 have come into substantially flush contact with each other. Here, the protrusions 20 and 30 have deformed the surfaces of the bolt head 80 and the first mating part 90 at the contact points 25 and 26 and vice versa. In detail, the deformation of the protrusions 20 and 30 may be seen in that the protrusions 20 and 30 are flattened by an amount indicated as Δh (delta h) and widened by all amount indicated as Δd (delta d).

In an exemplary embodiment of the invention, and, as shown in FIGS. 1 and 2, the protrusions 20 and 30 may be substantially rounded. Here, the curved geometry of the protrusions 20 and 30 is maintained even after the deformation of the protrusions occurs and offers a high local stiffness that increases a resistance to rotation. However, it is noted that the protrusions 20 and 30 need not be rounded or circular and that other shapes may be employed. Among these are conical shapes in which the protrusions 20 and 30 are characterized by a point alt their distal ends.

Although their size and shape may vary, the protrusions 20 and 30, may have specific sizes and shapes relative to those of the washer 10. For example, with reference to the dimensions shown in FIGS. 1 and 2, which are not drawn to scale, in the embodiment including rounded protrusions 20 and 30, where a diameter of the protrusions 20 and 30 is approximately d and the width of the face of the washer 10 is approximately w, 0.1<d/w<0.5. Also, where the height of the protrusions 20 and 30, as measured from the face of the washer, is approximately h and the thickness of the washer is approximately t, 0.16<h/t<0.32. Similarly, for the conical protrusions 20 and 30, where the transverse width of the conical protrusions 20 and 30 is approximately d and the width of the conical protrusions 20 and 30 is approximately b, 0.1<d/w<0.5 aid b/w=1.

In accordance with embodiments of the invention, as the force, F, increases and deformation occurs, the deformation reaches equilibrium as the respective surfaces of the bolt head 80 and the first mating part 90 come into substantially flush contact with the corresponding faces 15 and 16 of the washer 10. Further, the dimensions of the protrusions 20 and 30 may be set such that the decreases in the heights thereof and/or increases in the sizes of footprints thereof are functions of the yield strength of the material of the washer 10 and/or the materials of the fastener body 50 and the first mating part 90.

In an embodiment of the invention, the fastener assemblies disclosed herein, such as fastener assemblies 40 and 41, can be used in a wind tower flange fastener assembly. In such an application, the fastener body 50 and the shank receiving member 110 are made of materials listed in, e.g., ISO 898-1 or any other similar material. The fastener body 50 and the shank receiving member 110 are rolled and the threads 70 are formed using cold rolling techniques. Alternately, the fastener body 50 and the shank receiving member 110 may be machined. The washer 10 and the first and second mating parts 90 and 100 are each made using similar techniques but with different materials such that the mechanical properties of each of the features differ.

For example, upon an initial construction of the second fastener assembly 41, torque is applied to the shank receiving member 110 to obtain pre-loads which are 60-70% of the anticipated yield strength to support service loads caused by bending and vibrations of the wind tower during the lifetime of the second fastener assembly 41. As such, the pre-loading may generate a stress on the fastener body 50 of at least 590 MPa using a torque of approximately 2800 Nm. Here, it is noted that, while torque is typically employed to achieve the desired pre-loads, other methods of achieving the desired pre-loads are available. Further, in practice, the torque value is typically adjusted based on testing to obtain the desired pre-loads. The torque may vary significantly depending on the lubrication used, the types of fasteners used, etc.

With such pre-loads considered, the materials and certain dimensions of the protrusions 20 and 30 are selected to facilitate the flattening of the protrusions 20 and 30 as well as the penetration and deformation of the respective surfaces of the fastener body 50 and the first mating part 90.

For example, the yield strength of the first mating part 90 may be approximately 50 ksi or 350 MPa while the yield strength of the fastener body 50 may be approximately 130 ksi or 940 MPa. The washer 10 may have a yield strength exceeding that of the shank and a hardness that is described as either minimally rated at RC 32-39 or 2-5% harder than that of the fastener body 50. Here, the rallies describing the hardness of the material of the washer include all of the sub-ranges therein. Further, it is noted that, despite having relatively high yield strength and hardness, the material of the protrusions 20 and 30 experiences the deformation discussed above due to the high localized stress that is generated upon the tightening of the first and second fastener assemblies 40 and 41. That is, the relative strength and hardness of the washer 10 insures that the washer material is sufficiently hard enough to withstand the generation of the pre-loads without the protrusions being excessively deformed. Similarly, the materials of the fastener body 50 and the first mating part 90 are selected to insure that the deformation of these features also proceeds without failure.

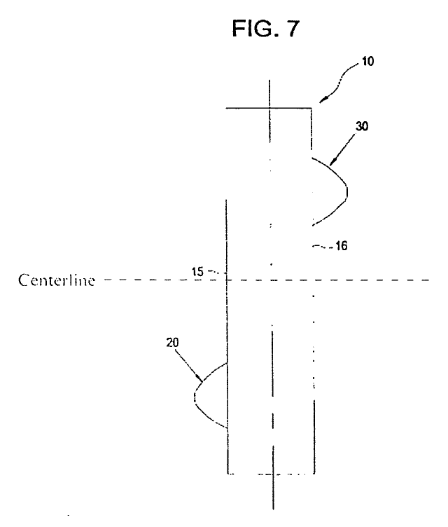

In an embodiment of the invention shown in FIG. 7, the washer 10 may be formed such that the protrusions 20 and 30 are not accompanied by indentations. That is, while the indentations, which are designated by the dotted lines of FIG. 2, are generated when the protrusions 20 and 30 created, the protrusions 20 and 30 could also be formed by other processes, e.g., machining, that do not form the indentations. Washers with and without indentations may be used interchangeably with one another in any embodiment of the invention.

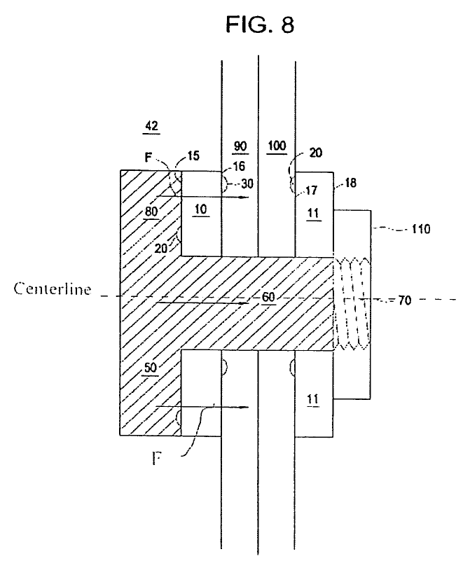

In another embodiment shown in FIG. 8, a third fastener assembly 12 includes a second washer 11 having faces 17 and 18 disposed between the shank receiving member 110 and the second mating part 100. Here, the second washer 11 includes protrusions 20 that are similar to those of washer 10 on face 17.

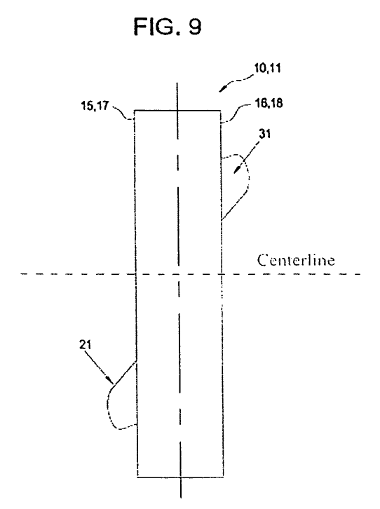

In another embodiment, shown in FIG. 9, the washer 10 or the second washer 11 may include angled protrusions 21 and 31. Here the angled protrusions 21 and 31 are tilted by between 35 and 70 degrees. Such angled protrusions 21 and 31 may be employed on any of the faces 15-18 of the washers 10 or 11 that turn against surfaces they contact. The angle of the angled protrusions 21 and 31 is in direction agreement with the direction of the turning and, as such, does not substantially affect the tightening process.

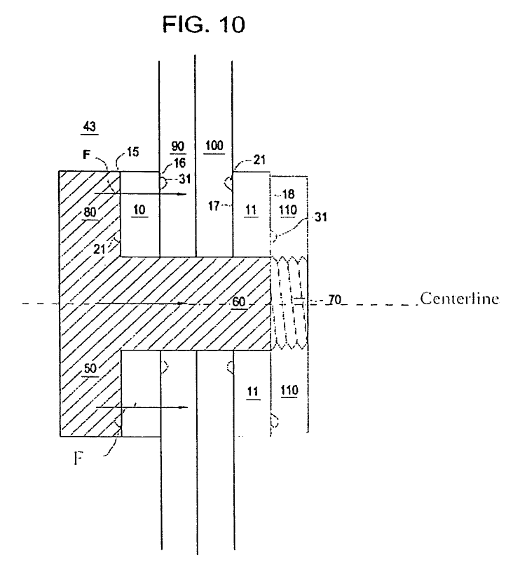

In an example of a fourth fastener assembly 43 shown in FIG. 10, the angled protrusions 21 and 31 of FIG. 9 are provided on faces 15-18 of the first and second washers 10 and 11. Here, as the shank receiving member 110 is tightened, the angled protrusions 21 and 31 increase a locking degree between the washers 10 and 11 and the surfaces they contact. While the washer 10 is shown with angled protrusions 21 and 31, it is understood that the washer 10 could also include the non-angled protrusions 20 and 30 in this embodiment.

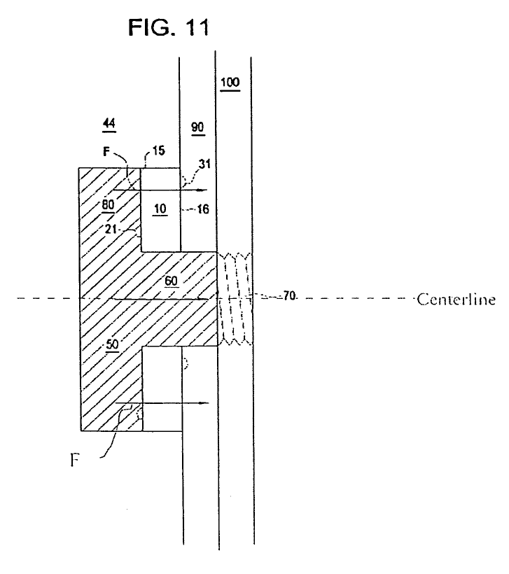

The angled protrusions 21 and 31 may also be applicable to the construction of the washer 10 in a fifth embodiment of a fastener assembly 44 shown in FIG. 11, in which the shank 60 tightens directly into the second malting part 100. Here, the fastener body 50 is turned during the tightening and the angled protrusions 21 and 31 appear on at least one of the faces 15 and 16 of the washer 10. Consequently, as the fastener body 50 comes into increasingly tight contact with the washer 10, the angled protrusions 21 and 31 each increase a locking degree between the washer 10 and the surfaces it contacts.

In addition to the advantages noted above, the washer 10 and the second washer 11 are relatively easy to manufacture whether by machining processes, punch processes, other processes and/or combinations thereof.

This written description uses examples to disclose the invention, including the best mode, and to enable any person skilled in the art to practice the invention, including making and using any devices or systems. The patentable scope of the invention is defined by the claims, and may include other examples that occur to those skilled in the alt. Such other examples are intended to be within the scope of the claims if they have structural elements that do not differ from the literal language of the claims, or if they include equivalent structural elements with insubstantial differences from the literal language of the claims.

1. A washer, comprising:
a body having:
a first face,
a second face, and
an aperture extending through the body from the first face to the second face; and
a plurality of protrusions extending from at least one of the first face and the second face, the plurality or the protrusions having sufficient structural integrity to create a plurality of corresponding deformations in a separate mating surface during compressive loading of the washer against the separate mating surface.

2. The washer according to claim 1, wherein the plurality of protrusions are organized on the at least one face so as to promote substantially uniform deformational imprints in the separate mating surface during the creation of the corresponding deformations.

3. The washer according to claim 1, wherein the washer further comprises materials having a higher yield strength and hardness than those of the separate mating surface.

4. The washer according to claim 1, wherein the protrusions are rounded.

5. The washer according to claim 1, wherein the protrusions are conical and comprise a point at respective distal ends thereof.

6. The washer according to claim 1, wherein portions of the face of the washer opposing locations of the protrusions are substantially flat.

7. The washer according to claim 1, wherein the creation of the deformations in the separate mating surface and corresponding deformations of the protrusions reach equilibrium with one another.

8. A fastener assembly comprising:
a fastener body having a shank and a bolt head;
a shank receiving member capable of drawing the bolt head in a direction to shorten a distance between the shank receiving member and the bolt head; and
a washer having a plurality of protrusions extending from at least one surface of the washer, the protrusions being capable of deforming at least one of the bolt head and a surface with which the washer makes contact during the drawing of the bolt head in the direction to shorten the distance between the shank receiving member and the bolt head.

9. The fastener assembly according to claim 8, wherein the washer comprises a body having:
a surface opposing the at least one surface; and
an aperture extending through the body from the surface to the opposing surface.

10. The fastener assembly according to claim 9, wherein the shank extends through the aperture with the body of the washer disposed between corresponding surfaces of the bolt head and the surface with which the washer makes contact during the drawing of the bolt head in the shortening direction.

11. The fastener assembly according to claim 10, wherein the body of the washer, the bolt head and the surface with which the washer makes contact remain substantially in parallel with one another during the drawing of the bolt head in the shortening direction.

12. The fastener assembly according to claim 8, wherein the yield strength of the washer exceeds that of the fastener body.

13. The fastener assembly according to claim 8, wherein the washer comprises a material having a hardness of approximately RC 32.

14. The fastener assembly according to claim 8, wherein the washer comprises a material having a hardness of up to approximately RC 39.

15. The fastener assembly according to claim 8, wherein the washer comprises a material that is approximately 2-5% harder than the materials of the fastener body and the surface with which the washer makes contact.

16. The fastener assembly according to claim 8, wherein the deformation of the at least one of the bolt head and the surface with which the washer makes contact and a corresponding deformation of the protrusions reach equilibrium with one another during the drawing of the bolt head in the shortening direction.

17. The fastener assembly according to claim 16, wherein the protrusions are angled with respect to an axis perpendicular to the at least one surface of the washer.

18. The fastener assembly according to claim 17, wherein the angling is in angularly directional agreement with an angular direction of a rotation of the fastener body or the shank receiving member with respect to the other about a longitudinal axis of the shank that accomplishes the drawing of the bolt head in the shortening direction.

19. A fastener assembly comprising:
a fastener body, including a shank and a bolt head;
a washer, disposed between a mating surface of the fastener body bolt head and a mating surface of a mating part, the washer including:
a body having first and second faces and an aperture extending through the body from one face to the other, and
a plurality of protrusions protruding from at least one of the faces; and
a shank receiving member configured to draw the mating surface of the fastener body bolt head toward the mating surface of the mating part such that the mating surfaces contact the first and second faces of the washer following sufficient deformations of each of the protrusions and the at least one corresponding mating surface.
